(19) United States
(12) Patent Application Publication
(10) Pub. No.: US 2024/0306762 A1
(43) Pub. Date: Sep. 19, 2024

(54) INSOLE AND COMBINATION THEREOF

(71) Applicant: TAOBODY LIFETIME HEALTHINESS, INC., Taipei (TW)

(72) Inventor: Ching-Fu TSAI, Taipei (TW)

(73) Assignee: TAOBODY LIFETIME HEALTHINESS, INC., Taipei (TW)

(21) Appl. No.: 18/263,401

(22) PCT Filed: Jan. 25, 2022
(86) PCT No.: PCT/CN2022/073875

§ 371 Date: Jul. 28, 2023

(30) Foreign Application Priority Data
Jan. 28, 2021 (CN) 202110118325.X

(51) Int. Cl. A43B 7/1455; A43B 17/00; A61H 39/04

(52) U.S. Cl. CPC A43B 7/146; A43B 17/00; A61H 39/04; A61H 2201/165; A61H 2205/125

(57) ABSTRACT

An insole combination, comprising an inner insole, an outer insole, and at least one stimulating medium. The inner insole has a plurality of first engaging portions, one upper surface, and a plurality of mark regions, which respectively correspond to a plurality of plantar reflexology areas. The outer insole has a plurality of second engaging portions, and the inner insole is accommodated in the outer insole. The stimulating medium is accommodated between the inner insole and the outer insole, and has one first holding end and one second stimulation end to perform a stimulating effect on the pelma.

### FIELD OF THE INVENTION

The present invention is related to a footwear item, particularly one with health care function.

### BACKGROUND OF THE INVENTION

The foot is the root of the human being, and is a center where the essence of the human body gathers, so it is nicknamed as a “second heart” of the human body. Nevertheless, the foot is the part being the farthest from the heart and has the lowest position, so the peripheral blood circulation thereof is poorer and the blood thereof is easy to stagnate. In daily health care, it is often necessary to smoothen the blood circulation at the foot, which plays an important role in ensuring normal running of vital energy (qi) and blood of the entire body. This is the basis by which customers are drawn to get foot massages. This is a lifestyle for many people all over the world. Obviously, they believe that foot massage has the functions of cultivating root energy, dredging meridians, strengthening the body, getting rid of diseases, and regulating autonomic nerves. In other words, pressing on the foot surface can activate the body's regulating function, stimulate the potential of cells in various organs, and enhance immunity. Newspapers, magazines and clinical practices have proved that foot massage therapy has sufficient effects on chronic diseases, such as neurasthenia, insomnia, digestive tract diseases, lower back and/or leg pain, diabetes, bronchitis, senile dementia, heart disease or cancer prevention, or preventive diseases. Therefore, it is said that a person who walks barefoot on a cobblestone road for a certain time or for a certain distance every day will feel no pain and have no side effects, and this is really a natural therapy which can eliminate or prevent the need for taking medicine or injections. It is a pity that not everyone has his/her home adjacent to, or has the time or opportunity to experience the cobblestone road.

### SUMMARY OF THE INVENTION

Foot therapy, or called reflexology therapy or zone therapy, seems to have originated in China and has a history of more than 3,000 years. The theory of the foot therapy is that specific areas of the human foot or hand can correspond to specific organs of the body. Therefore, the therapeutic effect can be achieved by patting, stimulating or massaging the specific areas. If observed from the meridian theory of traditional Chinese medicine, it seems better to explain the close relationship between the foot and the entire body. That is, the meridian system is closely connected with all organs of the body to constitute a unified circulation of the entire body. In the fourteen meridians of the human body, there are six meridians (i.e., three yin meridians of foot and three yang meridians of foot) that run through the foot, and are the beginnings of the three yin meridians of the foot and the ends of the three yang meridians of the foot. Among the eight extraordinary meridians, the Yin Heel Vessel, Yang Heel Vessel, Yin Link Vessel and Yang Link Vessel all originate from the foot, while the Chong Vessel has branches extended to the foot. Therefore, it is taken for granted that the changes in visceral function are reflected by the foot. Foreign literary works regarding the reflexology therapy for hand and foot include Eunice D. Ingham (American): Stories the Feet Can Tell Thru Reflexology published in 1930 and Mildred Carter (Swiss): Hand Reflexology: Key to Perfect Health published in 1975. As for public recognition, the British Association of Modern Medicine officially designated the foot massage method as the “Modern Medical Health Method” in 1985, and the “Foot Reflexology Conference” was held in California, U.S.A. in 1989.

The human body is like a small universe. Every message revealed by the surface of the body contains the inner mystery of an organ of the body. The various systems and organs in the small universe are linked, separately function and cooperate with each other, and are integrated through blood vessels, nerves, lymph glands and meridians, so the foot can be a mirror that reflects the organs of the human body. In fact, not only the foot, but also all the extremities of the human body, such as the ear, nose, head, the entire body skin, palm, hand back, foot, and even eyeball have this capability. However, because the foot is the farthest from the heart, it is the part getting the blood transported at the latest, so if the foot being the farthest from the heart can be properly taken care of, the healthiness of other parts will be self-evident.

However, according to studies and analyses of experiences in countries around the world, it seems that the effect of massaging the foot reflexology areas is the most significant. Most likely because the foot gathers myriad capillaries, which are the junctions of arterioles and venules that transport and exchange blood, and is replete with peripheral nerves, the foot is the most important reflexology area of the body and can best reflect the information transmission about circulation, metabolism, and nerve impulse.

“Meridian” is an abstract concept in the development of Chinese medicine. Some people consider that there are more than one hundred acupoints in the human body, while others think that there are more than two hundred or three hundred. People in the international meridian circle have set the total number of acupoints at three hundred and sixty five, which is like one acupoint per day and is easy to remember. However, the so-called three hundred and sixty five ones actually include the acupoints on the twelve meridians on one side plus the ones on both the Conception and Governor Vessels. Nevertheless, due to symmetry, at least additional three hundred and nine acupoints should be included. If the extraordinary acupoints or ear acupoints outside the meridians are counted, the total number of acupoints must exceed one thousand. If a scientific instrument is used, the “potential difference” at each acupoint can be measured and its value is different from that of others.

How many reflexology areas are there on a foot is generally determined by practitioners to be around 60, which is based on theoretical deduction in the early stage, and subsequent experiences or systematic research methods, such as pressing the skin inch by inch, and detecting when a specific reflexology area is pressed, where there is a response, or which viscera, organ, body function or part is improved after a certain amount of time. In practice, foot massage uses two operations including pressing and rubbing to respectively obtain reinforcing and reducing effects for an organ of insufficient and excessive qi to restore the original balance of yin and yang. In detail, according to traditional Chinese medicine, massage operations can be subdivided into ten types: pressing, rubbing, pushing, holding, kneading, pinching, pointing, scraping, smoothing, and buckling. “Pressing” refers to pressing or depressing on a fixed-point, which is to reduce the energy load and has the effect of “reduction”. “Rubbing” refers to rubbing or scraping with movement, which is to make up the energy insufficiency and has the effect of “reinforcement”. Therefore, when the energy is too high, press it by hand to reduce the load; and when the energy is too low, rub it by hand to make up the insufficiency.

Regardless of traditional Chinese medicine or western (or modern) medicine, the relevant foot therapy actually involves three principles, namely the principles of reflection, circulation and balance. In the former (Chinese medicine), the principles respectively refer to the principles of meridian reflexology, qi and blood circulation, and balance of yin and yang/generation and restraint of the five elements; while for the latter, the principles respectively refer to nerve reflexology, blood circulation and endocrine balance. No matter what the principles are, health can be maintained thereby. It is reported that, if all blood vessels in the human body, including arteries, veins, and capillaries, are connected in a line, it can circle the earth about two and a half times. Therefore, if a shoe is too tight, the blood vessels in the foot will be blocked, causing the blood unable to flow back smoothly, resulting in poor blood circulation, which in turn makes it difficult to transport nutrients or oxygen to the entire body, or to excrete the waste, resulting in foot edema. If the cells are necrotic because of this, either when the cells are merely surface cells of the body, the skin will peel off through keratinization, or when the tissue necrosis occurs in an internal organ, the organ will become diseased, leaving a room for cancer cells to grow.

The “reflexology principle” comes from extremely subtle or complicated “stimulus-response” physiological phenomena, and has three elements of “connection”, “cooperation” and “coordination”. In other words, the yin/yang harmony in the body originates from and is maintained through continuous and orderly connection, cooperation, and coordination among the various body systems. “Reflexology” is like an involuntary reaction, which is the response action of organs, glands or muscles induced by external stimuli due to the conduction of “energy current”. The body surface and the interior are filled with rich and sensitive receptors. When the external or internal environment of the body changes, the receptors will detect nerve impulses, which will be transmitted along the afferent nerves to the central nervous system, which will coordinate and induce new nerve impulses. New nerve impulses are transmitted along efferent nerves to organs, glands, or muscles, finally generating physiological responses. Nerve fibers from the motion areas of the cerebral cortex pass through the back of the medulla, forming a cross. A stimulus is then transmitted downward to the spinal cord area, and then to the muscle or other cell tissues by the efferent nerve. Likewise, a stimulus information coming from the skin, through the afferent nerves is transmitted upward to the medulla along the spinal cord. Because of crossover of the nerve fibers (“sensory decussation”), the nerve impulses are transmitted to the optic thalamus and then upward to the cerebral cortex sensory areas.

Although the foot is the farthest part from the heart, the reflexology areas thereof are located at the nerve endings, which are also the most sensitive reflexology areas of the human body. From another aspect, if there is disease or function decline in limbs or organs, the soles of the feet, which are the terminal signal receptors, will immediately reflect at least part of the change information. For example, when we experience massaging or stimulating a certain corresponding/reflexology point on the foot, it is reported that the (electro-chemical) nerve impulses of the body will induce a change in the nerve potential, which will be transmitted through the afferent nerve to the spinal ganglion at a speed of 120 meters per second, and then through the efferent nerves to the relevant parts or organs, which induces the visible response. Although this instant reflexology action is not directly commanded by the brain, the impulses are still transmitted along the spinal cord upward cross the medulla, and then reach the sensory area of the cerebral cortex, inducing pain information of different degrees.

If the channels for energy transmission in the body, such as blood vessels or lymphatic vessels, are blocked for some reason, metabolic waste and impurities will be deposited on the circulation channels, and adversely affect the normal functions of cells/organs. On the contrary, if an organ suffers from a disease of various extent, information of such poor circulation or impulsion function will be transmitted to the brain and limb reflexology areas through the ending nerves and peripheral nerves connected to the organ. At least for the sake of gravity, the deposition information is easy to gather on the foot sole. Therefore, theoretically, the existence and strength of the information from the reflexology area can be used to judge or perceive whether the relevant organ is functioning well. In practice, the foot rehabilitation trainer promotes the circulation and metabolism of impurities and sediments in the foot through massage or stimulation, and excretes them from the body through the relevant viscera.

Physically, the electromagnetic physical characteristics of the positive and negative poles induce energy exchange through the pole interaction. “Yin-yang balance” in the Chinese philosophy seems interpretable in the same way. If the head and foot are regarded as the two main endpoints to form two poles of the energy flow cycle, it is very likely that we can thus rely on the accumulated experiences in history, helping the foot rehabilitation trainers determine the specific reflexology points of various organs on the foot sole according to their own skill inheritance. Through the principle of reflexology or reflexology area, it can further be clinically verified by modern medicine or technology or discussed in details on the theoretical basis. Our confidence will be boosted in view of the Chapter “Conjecture from external observation” of “Lingshu Jing” of Huangdi (Yellow Emperor) Neijing, where it records “the shining light cannot be concealed, because it does not go beyond yin and yang. To observe the patient comprehensively, to verify by palpation, and to detect by inspection, the disease can be diagnosed accurately through how every detail looks like. If a patient's 5 voices or 5 colors are not clear, and the five organs fluctuate, there must be interaction between the internal and external universes, just like the drum will react with the drum stick, the sounding wave reacts with the sound, and the shadow simulates the target shape. Therefore, observing the external aspects from a distance can infer the changes of internal organs, and observing the changes of organs from a close distance can also infer external manifestations. Thereafter, we can assert we know the essence of yin and yang, and the extremities of the sky and earth. We should keep it in the room of the spirit orchid without leaking it out.”

So far, it seems that we should be convinced that foot therapy is infinitely good. However, the reasons why the present invention is different from the prior art and how we can enjoy it have not been revealed yet, and what the preceding discussions have to do with the present invention also needs be detailed. Specifically, the first objective of the present invention is to try to integrate the principles of foot therapy into daily life.

The second objective of the present invention is to integrate the principle of foot therapy into the footwear.

Yet another and other objectives of the present invention are to focus on enabling us to obtain the effect of foot therapy at a relatively low cost.

### BRIEF DESCRIPTION OF THE DRAWINGS

The embodiments are depicted by the examples, and are therefore merely illustrative of inventive concepts.

FIG. 1 is a schematic diagram of the plantar reflexology areas;

FIG. 2 is a schematic diagram of the first embodiment of the insole of the present invention;

FIG. 3A is a schematic diagram of the second embodiment of the insole of the present invention;

FIG. 3B is a schematic diagram of semi-spherical grains used to match the second embodiment of the insole of the present invention;

FIG. 3C is a schematic diagram of the third embodiment of the insole of the present invention;

FIG. 4A is the schematic diagram of the fourth embodiment of the insole of the present invention;

FIG. 4B is a schematic diagram of the bump device used to match the fourth embodiment of the insole of the present invention;

FIG. 5 is the schematic diagram of the fifth embodiment of the insole of the present invention;

FIG. 6A is a schematic explosion diagram of the sixth embodiment of the insole of the present invention;

FIG. 6B is a schematic diagram of the stimulating medium used in the sixth embodiment of the insole of the present invention;

FIG. 7A is the schematic diagram of the seventh embodiment of the insole of the present invention;

FIG. 7B is a schematic diagram of the eighth embodiment of the insole of the present invention;

FIG. 8 is a schematic cross-sectional view of the ninth embodiment of the insole of the present invention;

FIG. 8A is a partially enlarged schematic diagram of the ninth embodiment of the insole of the present invention;

FIG. 9 is a schematic cross-sectional view of the tenth embodiment of the insole of the present invention;

FIG. 10 is an explosion diagram of another embodiment of the stimulating medium of the present invention; and

FIG. 11 is a schematic cross-sectional view of the eleventh embodiment of the insole of the present invention.

### DETAILED DESCRIPTION OF THE PREFERRED EMBODIMENTS

With reference to the drawings, it is disclosed how the present invention achieves the above-mentioned objectives one by one. Because people's wisdom is developing day by day, simulation with slight differences is easy. Therefore, the following specific implementations are used to assist in understanding how a specific embodiment of the present invention can achieve the objectives of the present invention, rather than the only feasible way or limit observed from the thinking angles of the present invention. Similarly, the descriptions of specific embodiments from different thinking angles of the present invention can often be referred to each other for replacement or modification.

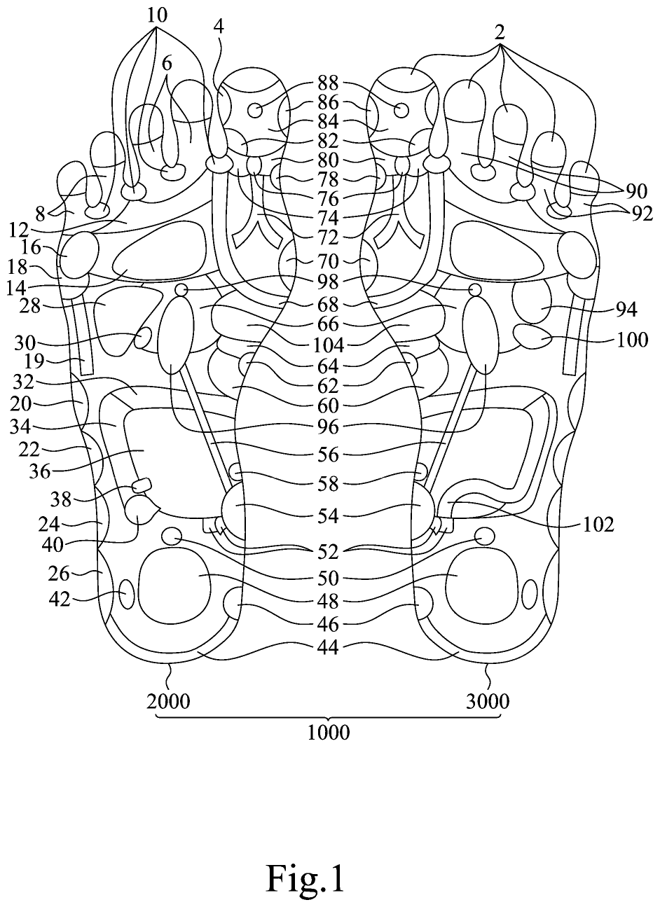

Please refer to FIG. 1, which is a schematic diagram of the plantar reflexology area. As different practitioners have their own techniques, the technique practiced by a specific one may be particularly effective for a certain reflexology area. Therefore, although the plantar reflexology areas operated by various practitioners are generally the same, there may be differences in the sizes of the areas, or there may be some same areas having slightly different locations. The applicant does not intend to say that FIG. 1 is the most authoritative, but it is depicted based on its hard-earned research or knowledge. As mentioned above, FIG. 1 shows more than 90% similarity to the ones mostly used in the field, and the remaining 10% or less depends on different people's knowledge and is left for future study or for a certain professional to prove and convince everyone.

Please refer to FIG. 1, which shows a pair of human feet 1000. Although most of the feet are symmetrical, there are exceptions, such as the liver reflexology area is located on the right foot 2000 (some practitioners object to this statement, and claim the two feet should be symmetrical), and the heart reflexology area is located on the left foot 3000. Therefore, we have to place the diagrams of the left and right feet together to see the whole picture. Reflexology areas include frontal sinus 2, trigeminal nerve and temporal lobe 4, left eye 6, left ear 8, head and neck lymph gland 10, mitral muscle (or trapezius muscle) 12, lung and bronchi 14, shoulder 16, armpit/cavity 18, upper arm 19, elbow 20, knee 22, shin 24, hip 26, liver 28, gallbladder 30, transverse colon 32, ascending colon 34, small intestine 36, ileocecal valve 38, cecum and appendix 40, cold site 42, sciatic nerve 44, headache site 46, gonad 48, insomnia site 50, rectum and anus 52, bladder 54, ureter 56, navel 58, duodenum 60, lumbago site 62, pancreas 64, celiac plexus (solar plexus) 66, thyroid gland 68, parathyroid gland 70, esophagus and trachea 72, neck 74, carotid artery 76, cervical spine 78, tongue and oral cavity 80, cerebellum/brainstem 82, head/brain 84, nose 86, pituitary gland 88, right eye 90, right ear 92, heart 94, kidney 96, adrenal gland 98, spleen 100, sigmoid colon 102 and stomach 104.

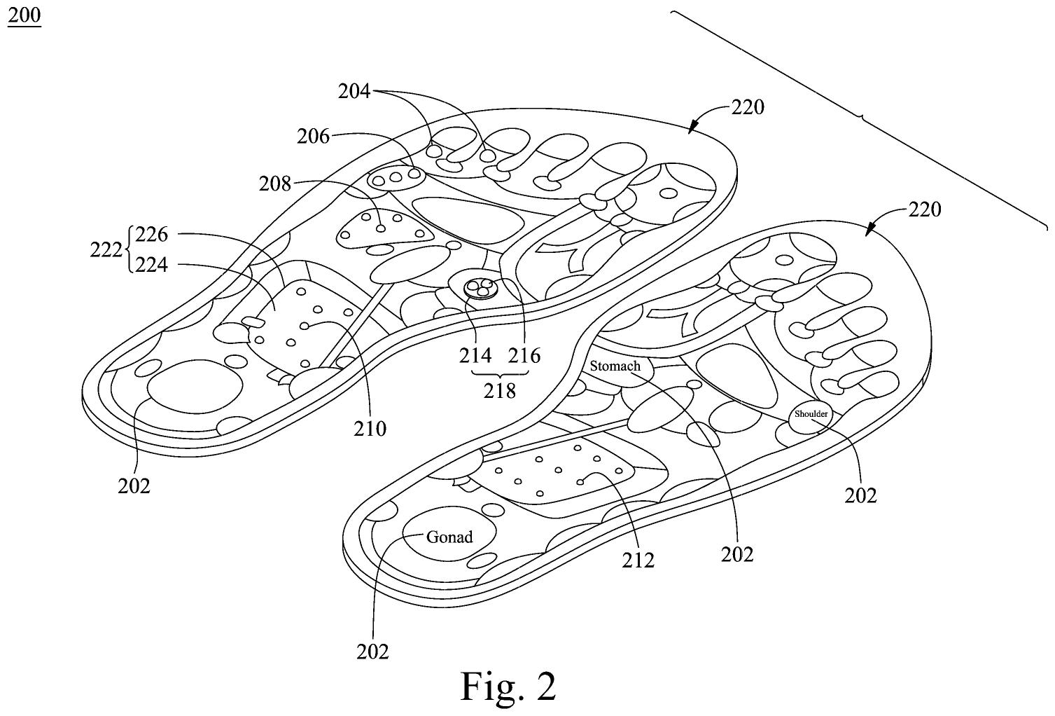

Please refer to FIG. 2, which illustrates an insole 200 of the first embodiment of the present invention. The name of each reflexology area 202 has been marked on the insole 200, so the user can easily know the specific reflexology area. If a person A has the following symptoms: left ear and shoulder pain, liver deficiency and intestine tenue indigestion, then we should dispose bumps 204 at the left ear reflexology area, bumps 206 at the shoulder reflexology area, and evenly bumps 208 at the liver reaction area, while bumps 210 and 212 are uniformly arranged in the reflexology area of small intestine 36. Then, when person A inserts insole 200 in its shoe, and walks, insole 200 and the ground will automatically combine to force person A to perform foot therapy.

The size of each of bumps 204-212 can vary according to the size of each reflexology area, and the number thereof can be changed accordingly. For example, as shown in FIG. 2, the bumps have different sizes. For another example, a larger stimulating medium 218 can be disposed on the pancreatic reflexology area, which includes a bump platform 214 and three small bumps 216 disposed thereon. However, no matter how these two parameters including the bump number and size change, to achieve maximum massage effect is taken as the criterion.

Here is a summary of the first embodiment according to the present invention. An insole 200 adapted for use in a footwear is disclosed, wherein the footwear has an inner bottom upper surface, the user has a sole having a bottom surface stepping on the inner bottom upper surface, insole 200 is arranged between the inner bottom upper surface and the bottom surface, and insole 200 comprises an insole body 220 having a shape conforming to an outline of the inner bottom upper surface, and a plurality of marked regions 222 disposed on the insole body, configured to respectively correspond to a plurality of plantar reflexology areas on the sole. Marked regions 222 each has a specific area 224 corresponding to a region (2-102) on the surface that reflexes to a related organ or a body part, and a marking line 226 configured to at least partially enclose a specific area 224 for allowing the user to easily identify the specific area.

According to the embodiment of insole 200 mentioned above, it may further include a label name 202 marked on specific area 224.

According to the embodiment of insole 200 mentioned above, it may further include at least one stimulating medium 204 each adhered on specific area 224. Of course, each of marked regions 222 or specific areas 224 can be provided with a hole or marked with a marked symbol so as to facilitate adhesion or arrangement of stimulating medium 204.

According to the embodiment of insole 200 mentioned above, stimulating medium 218 has a platform lower portion 214 and a plurality of upper part stimulation bumps 216.

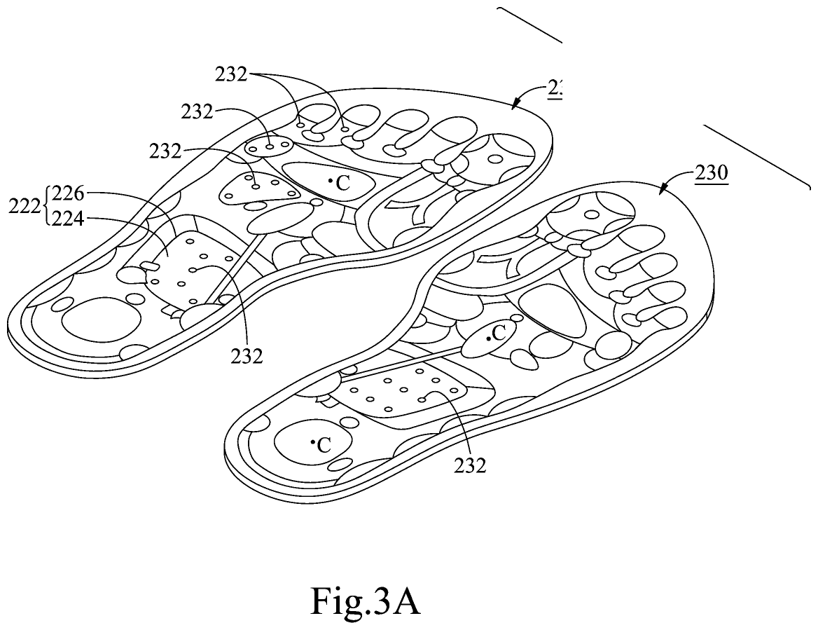

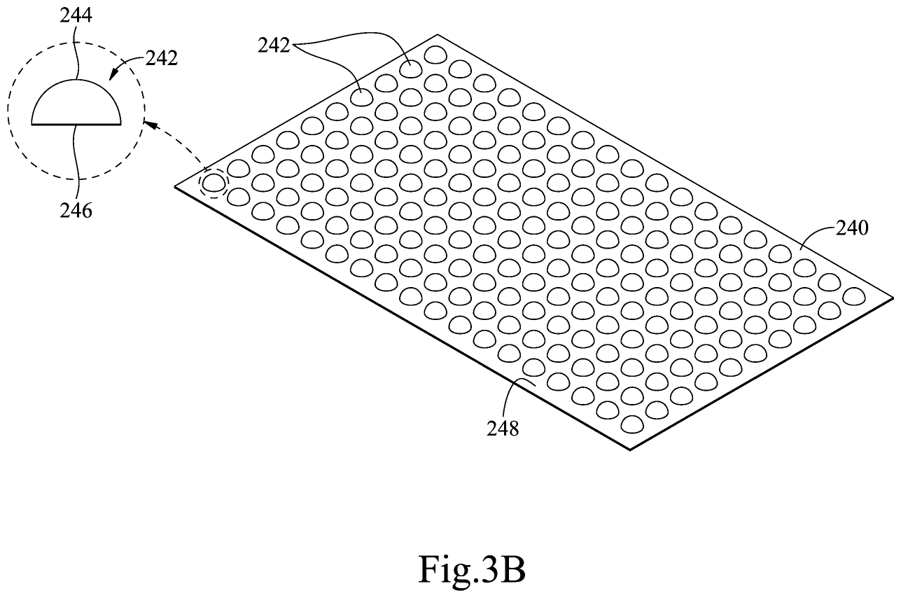

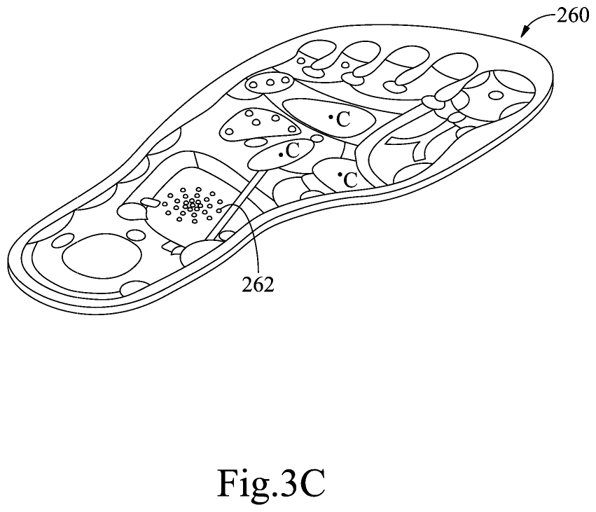

Please refer to FIG. 3A, according to the insole 230 of the second embodiment of the present invention, of course, the bumps can also be identical in size, and the number of the disposed bumps simply depends on the size of the reflexology area, with the consideration of uniform massage to the reflexology area. When disposed in this way, it provides the following advantages. As the world makes progress, various entertainment media are flooding in the market. For example, stickers 240 for use of children, as shown in FIG. 3B, have been upgraded to semi-spherical grains with a thin adhesive layer 246 temporarily adhered to a release paper 248. Children can stick the hemispheric grains to a canvas or wall one by one to complete a “painting”, “layout” or “decoration” as what they think. We can ask the consumer to buy stickers 240 at a stationery store, and use them as a massage/stimulating medium, and complete the insole with health care function of the present invention. In other words, what the consumers only need for assistance at this moment is the position indication for the reflexology area on the insole, and in each reflexology area, how should the disposition be arranged for stimulation. In this regard, based on the applicant's experiments, first, the effect to stimulate the center of the reflexology area is the most significant. Second, for a specific reflexology region, the effect of uniform stimulation to the entire region is remarkable. Third, if the same specific reflexology region is stimulated with multiple points, although the uniform stimulation effect of the entire region is good, the more stimulation points closer to the center of the region, the better the massage effect. As shown in FIG. 3C, it shows the insole 260 according to the third embodiment of the present invention. It illustrates that there are more bumps 262 at the position closer to center of the reflexology area of the small intestine 36 than the one at the position farther therefrom.

Here is a summary of the second and third embodiments according to the present invention. Insole 230 or 260 is disclosed. Similar to the first embodiment, insole 230 and 260 comprises insole body 220, marked region 222, specific area 224, and marking line 226. However, specific area 224 further comprises at least one stimulation position mark 232. Certainly, the shape and size of each of the stimulation position marks 232 can be identical.

According to the embodiment of insole 230 or 260 mentioned above, when the shorter the distance from the centroid C of the specific area is, the greater the number of the stimulation position marks is.

According to the embodiment of insole 230 or 260 mentioned above, it further comprises stimulation media 262, wherein each of the stimulation media has the same shape and size.

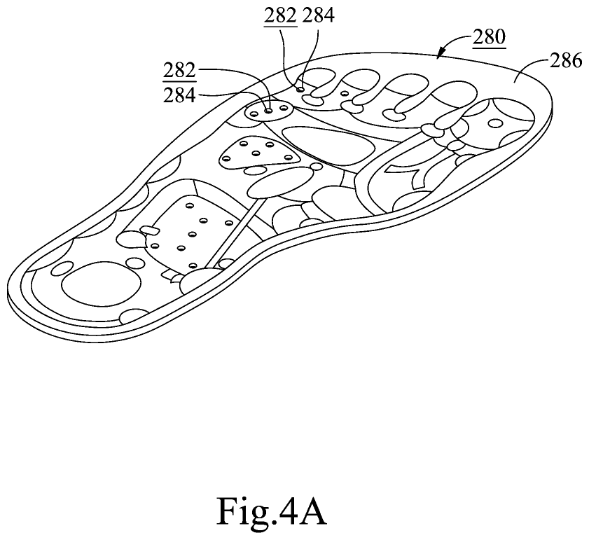

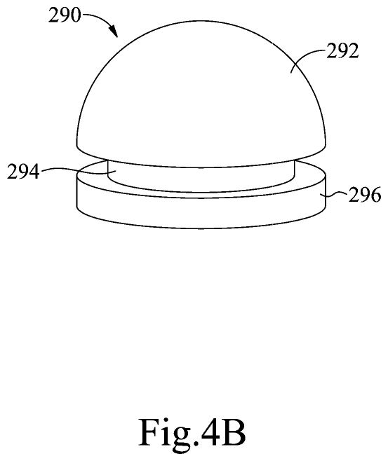

Please refer to FIG. 4A, which shows a schematic diagram of an insole assembly 280 according to the fourth embodiment of the present invention. The differences from the preceding embodiments are that one or more openings 282 are provided on the insole body 286 and corresponds to each of the regions, and each opening has a defining hole circumference 284. Please refer to FIG. 4B, it shows a matching stimulating medium. In this embodiment, it is a columnar body 290, which comprises a column upper part 292 for acting as a stimulating medium, a concave ring 294 for matching with the defining hole circumference 284, and a base 296 disposed or positioned between insole assembly 280 and the inner bottom upper surface, so that column upper part 292 can provide a stimulation.

Here is a summary of the fourth embodiment according to the present invention. An insole assembly adapted for use in a footwear is disclosed. The footwear has an inner bottom upper surface, the user has a sole having a bottom surface stepping on the inner bottom upper surface, the insole assembly is arranged between the inner bottom upper surface and the bottom surface, and the insole assembly further comprises: an insole body having a shape conforming to an outline of the inner bottom upper surface; a plurality of marked regions disposed on the insole body, configured to respectively correspond to a plurality of plantar reflexology areas on the sole and each reflexes to a related organ or a body part of the user; at least one stimulating medium; and at least one connecting medium. The plurality of marked regions each comprises a specific area corresponding to a region on the surface that reflexes to a related organ or a body part, a marking line configured to at least partially enclose the specific area for allowing the user to easily identify the specific area, and at least one stimulating medium each positioned with respect to the specific area by the connecting medium, and configured to provide a stimulation to the bottom surface when the user wears the insole assembly. The so-called at least enclosing the specific area means that the reflexology area may extend beyond the bottom surface, so the area corresponding to the insole body may only be a part of the entire reflexology area.

According to the insole assemble mentioned above, the connection medium is a hole provided on the specific area, and each hole has a defining hole circumference.

According to the insole assemble mentioned above, the stimulating medium is generally cylindrical, and includes a cylindrical upper part to serve as the stimulating medium, an intermediate annular groove matching with the defining hole circumference, and a base arranged between the insole body and the inner bottom upper surface to allow the cylindrical upper part to provide the stimulation.

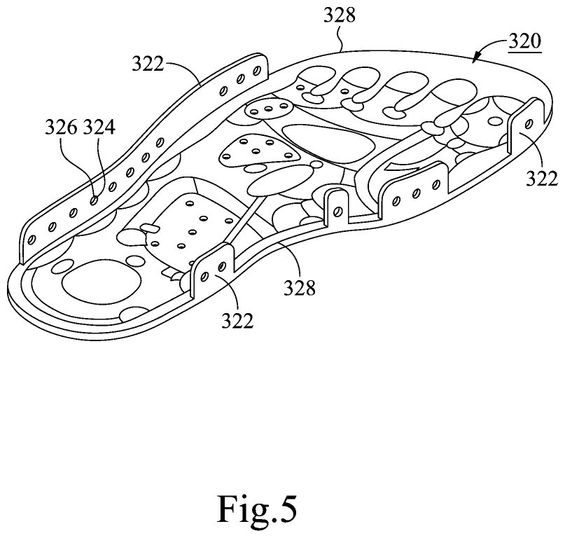

Please refer to FIG. 5, which shows a schematic diagram according to the fifth embodiment of an insole 320 of the present invention. The differences between it and the preceding embodiments are that the corresponding reflexology areas on insole 320 extend to the relevant reflexology areas on the sole side. For shoulder 16, armpits/cavity 18, upper arm 19, elbow 20, knee 22, shin 24, hip 26, nose 86, parathyroid gland 70, thyroid gland 68, pancreas 64, and bladder 54, side extensions 322 extend upward from both sides of insole 320 disposed with corresponding openings 324, each of which has a defining hole circumference 326 for engagement with the bump structure (not shown), so as to provide a stimulation to the sole bottom surface/or sole sides of the user who wears the insole. Certainly, in terms of the extension from the sole sides, it is also applicable to the first to fourth embodiments according to the present invention.

According to the insole or insole assembly of all the embodiments mentioned above, the user's sole has two sole sides, the sole has some specific reflexology regions, which extend laterally upward from the two sole sides. The insole body further includes two insole sides 328 and two side portions 322 laterally extending upwardly from two insole sides 328 to correspond to the some specific reflexology regions.

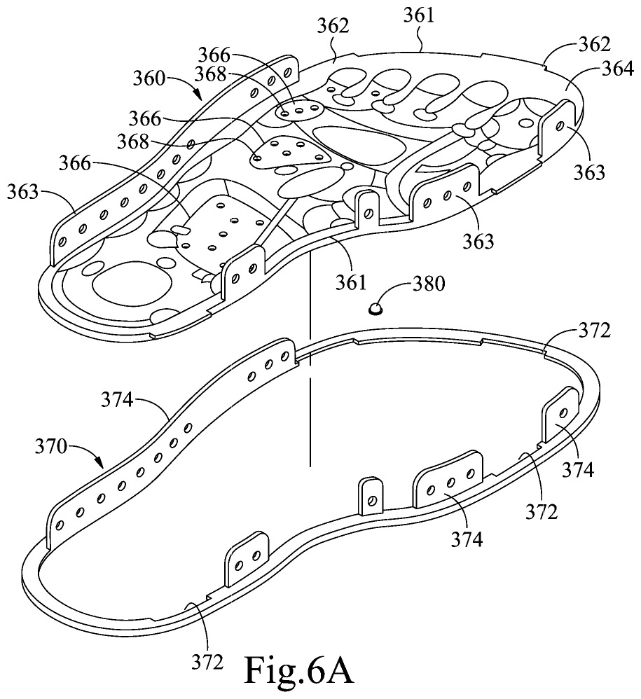

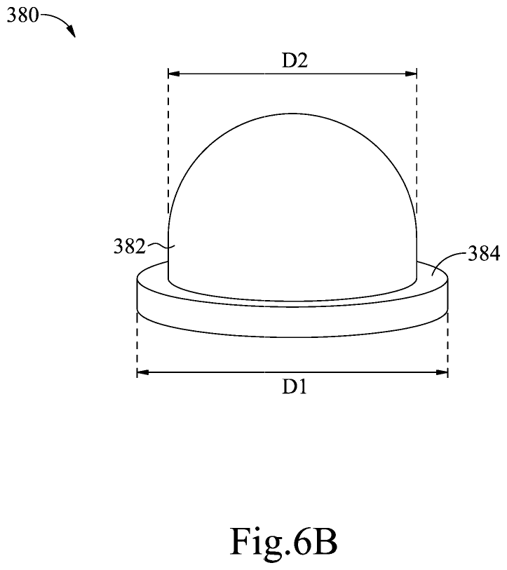

Please refer to FIG. 6A, which shows a schematic exploded view of the sixth embodiment of the insole 350 of the present invention. Insole 350 includes an inner insole 360, an outer insole 370 and a stimulating medium 380. Inner insole 360 can be similar to insole 320, and outer insole 370 is used to confine or hold inner insole 360 therein so that the simulating medium functions well. Certainly, two insole sides 361 of insole 360 can be equipped with two lateral extensions 363 so that the plantar reflexology areas extending along the two sole sides can also be served. For accommodating lateral extensions 363, outer insole 370 should be correspondingly equipped with two lateral extensions 374 to facilitate stimulating medium 380 to be sandwiched between the two pairs of the two lateral extensions 363, 374. As to stimulating medium 380, because it is confined between inner insole 360 and outer insole 370, it has a structure simpler than bump structure 290. As shown in FIG. 6B, stimulating medium 380 includes a stimulation body 382 and a base 384. Based on this design, because base 384 is simply sandwiched between inner insole 360 and outer insole 370, no further structure is required to match with the opening of inner insole 360. If the perforation 368 on inner insole 360 has a first pore size B, the first nesting end or base 384 has a second diametral size D1, and the second stimulating end or stimulation body 382 has a largest third diametral size D2, the relationships among them are that the second diametral size D1 is larger than the first pore size B, and the largest third diametral size D2 is approximately equivalent to the first pore size B. Certainly, the perforation having the diametral size can be a circular hole. However, we all know that it need not be circular. The important thing is that those elements can collaborate with each other, while it is not necessary to describe further in detail.

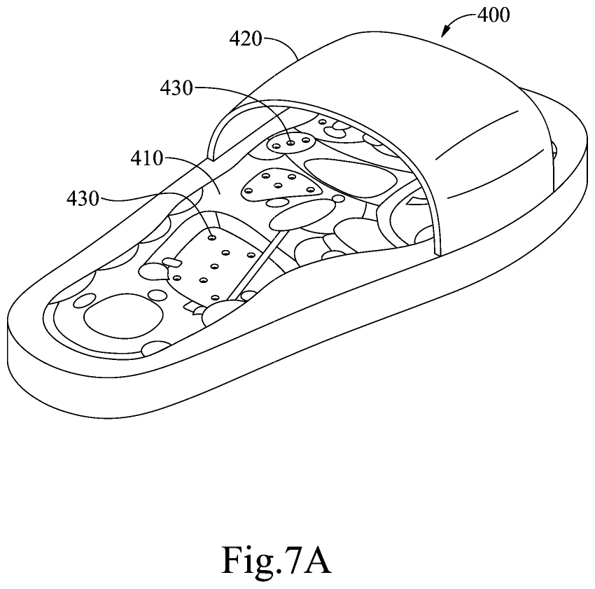

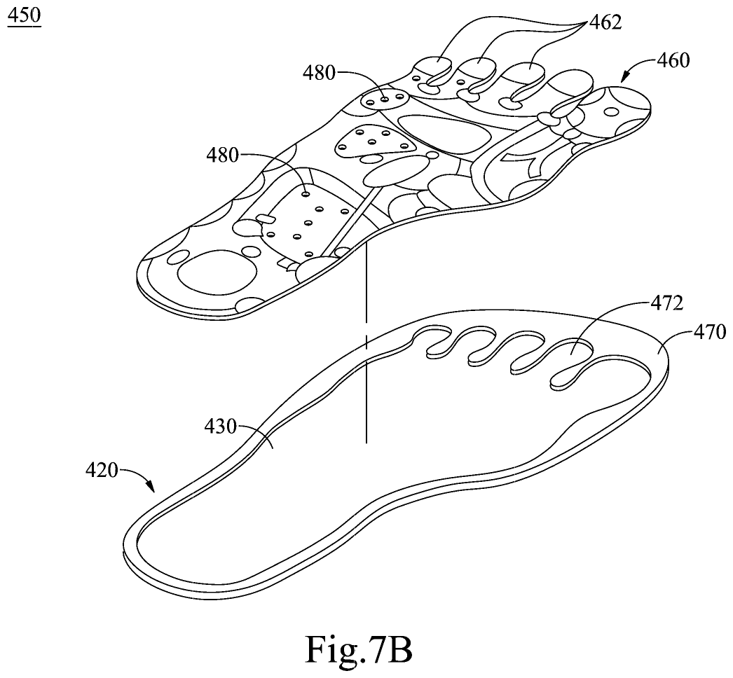

Please refer to FIG. 7A, which shows a schematic diagram according to a seventh embodiment of a footwear 400 of the present invention. The footwear includes an inner insole 410, an outer insole 420 and a stimulating medium opening 430 disposed therebetween. Footwear 400 has a function similar to insole 350, but outer insole 420 is made as a shoe body that can directly contact the ground or be used outdoors, such as slippers.

Please refer to FIG. 7B, which shows a schematic diagram according to an eighth embodiment of an insole 450 of the present invention. Insole 450 has a main sole insole 460, and a peripheral frame 470 jacketing thereto the main sole insole, wherein the five toes 462 of main sole insole 460 are separated from each other so as to be engaged with the five toe cavities 472 of peripheral frame 470. In addition, the relevant corresponding reflexology areas of inner insole 460 is provided with the stimulating medium opening 480 as mentioned above.

Here is a summary of the sixth to eighth embodiments according to the present invention. Insole assembly 350 (or 400) includes inner insole 360 (410), outer insole 370 (420) and at least one stimulating medium 380 (430) disposed therebetween. Inner insole 360 has a plurality of first engaging portions 362, upper surface 364, and a plurality of mark regions 366 disposed on the upper surface, wherein each the marked region has at least one perforation 368 and corresponds to a plantar reflexology area on a user's sole, and the plantar reflexology area reflexes to a user's related organ or body part, and outer insole 370 has the plurality of second engaging portions 370, and engaged with the inner insole by a mutual engagement of the pluralities of first and second engaging portions 362, 372. Inner insole 360 is accommodated in outer insole 370. A plurality of or at least one stimulating medium is accommodated between inner insole 360 and outer insole 370, each having first nesting end 384 confined between inner insole 360 and outer sole 370, and second stimulation end 382 penetrating inner insole upper surface 364 through corresponding perforation 368 to stimulate the sole. Certainly, if outer insole 370 has a slight peripheral protrusion, the second engaging portion will be a corresponding recess rather than a simple groove as shown in FIG. 6A. If it is in the form of a recess, it is obviously easier and more effective to retain first engaging portion 362. Obviously, there will be many derivatives resulting from variants of these embodiments, and so it is not necessary to describe further in detail.

According to the embodiment of insole assembly 350 (400) mentioned above, perforation 368 has a first pore size B, the first nesting end has a second diametral size D1, the second stimulating end has a largest third diametral size D2, the second diametral size D1 is larger than the first pore size B, and the largest third diametral size D2 is approximately equivalent to the first pore size B.

According to the embodiments of the insole assembly mentioned above, the outer insole can be shaped as slipper, sandal, sneaker, casual shoe or leather shoe.

According to the embodiments of insole assembly 350 (400) mentioned above, the sole has two sole sides and some specific reflexology regions extending laterally upwards along the two sole sides. Inner insole 360 (410) further includes two insole sides 361 and two side portions 363 extending laterally upward from two insole sides 361 and corresponding to the specific reflexology regions.

According to the embodiments of insole assembly 350 (400) mentioned above, the mutual engagement of the plurality of first engaging portions and the plurality of second engaging portions is based on a simple contact, or by a design of intermeshing protrusions and recesses.

Of course, the insole assembly does not necessarily have to be composed of the upper and lower insoles. In fact, the highest upper surfaces of the upper and lower insoles of insole 450 can also be in a form of a coplanar surface of the inner and outer insoles, such as an insole assembly including main sole insole 460 and peripheral frame 470 jacketing thereto the main insole, wherein five toes 462 of main sole insole 460 are separated from each other so as to engage with five toe cavities 472 of peripheral frame 470.

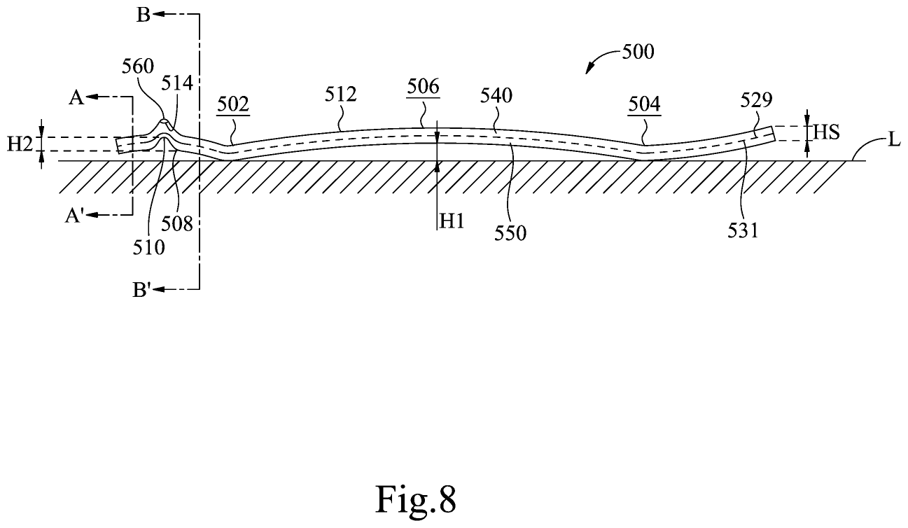

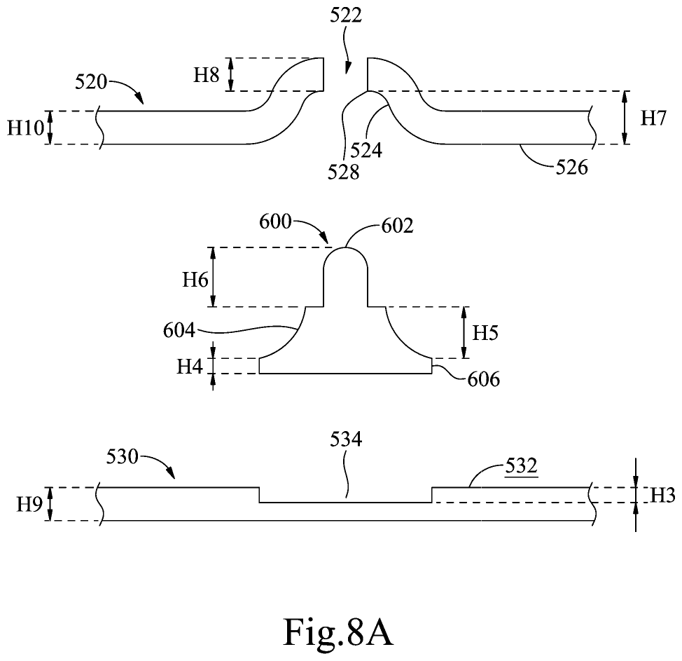

Please refer to FIG. 8, which shows a schematic longitudinal cross-sectional view of the ninth embodiment of the insole assembly 500 of the present invention. The height of the insole assembly is HS, which in the market reality is about 0.05 to 0.2 centimeters. When the sole of the foot is relaxed, the height of the frontmost point 502 of the metatarsal bone and the frontmost point of the calcaneus bone 504 is the lowest. If a line L is drawn through two points 502, 504, the distance between the line and the highest point 506 of the foot arch is H1, usually between 0.2 centimeter (for a flat foot) and 1 centimeter (for a foot having a high arch). It is the toe-sole contiguity area between the frontmost edge 508 of the sole and the highest bottom sole surface 510 of the proximal phalanx, where the height of the largest drop H2 is usually between 0.3 and 0.7 centimeter.

Please refer to FIG. 8A, which shows an enlarged diagram of the portion between line AA′ and line BB′ shown in FIG. 8. Insole assembly 500 is composed of an upper insole 520 and a lower insole 530. Upper insole 520 has at least one perforated structure 522 corresponding to a reflexology area such as eye 6 or ear 8. Perforated structure 522 has an inclined portion 524 and an upper opening 528. The upper insole has a lower surface 526 matching with upper surface 532 of lower insole 530, and upper surface 532 has at least one recess 534. Respective perforated structure 522 and recess 534 collaboratively assemble therebetween a stimulating medium 604. Stimulating medium 600 has a stimulating upper portion 602, a matching intermediate portion 604 and a lower assembling portion 606, where lower assembling portion 606 is accommodated in recess 534, and matching intermediate portion 604 and inclined portion 524 match each other, so that stimulating upper portion 602 protrudes from upper opening 528 of perforated structure 522 to stimulate a user's sole. It should be noted that inclined portion 524, matching middle portion 604 and recess 534 here show only one embodiment of the present invention, and their sole purpose is to preferably keep stimulating medium 600 between insole 520 and insole 530. We know that any design for stimulating medium 600 is suitable as long as it can be retained between upper and lower insoles 520 and 530. For example, even if lower surface 526 and upper surface 532 are completely flat, because the stimulating head of stimulating medium 600 (i.e., stimulating upper portion 602) will pass through the opening of the insole (i.e., 528), stimulating medium 600 can be appropriately restrained. Therefore, the purpose of positioning it between the upper and lower insoles has been achieved.

Please refer back to FIG. 8, the upper insole has a lower connecting portion 529, and the lower insole has an upper connecting portion 531. These connecting portions can be disposed on the toe area and the heel area, and its number can be one or more. Because the foot will step on it, there is no need to worry about their separation from each other, and the connection to each other can be very simple, such as through adhesion, various simple concave-and-convex designs or a tenon-and-groove fit. Furthermore, the upper insole 540 has at least one opening 514, so that the stimulation body 560 of the stimulating medium provided between the upper and lower insoles 540, 550 can pass therethrough.

We would like to define as follows. The height of recess 534 is H3, the height of lower assembling portion 606 is H4, the height of matching intermediate portion 604 is H5, the height of stimulating upper portion 602 is H6, the height of inclined portion 524 is H7, the height of upper opening 528 is H8, the height of lower insole 530 is H9, and the height of upper insole 520 is H10. We can list the relationship between these heights as follows: H9+H10=HS, H3=H4, H5=H7, and H6 is about 0.1-0.3 centimeter greater than H8 as the actual stimulation height. If the upper surface of insole assembly 500 matches the sole surface, the actual stimulation height of 0.1 centimeter is provided for light stimulation, while 0.3 centimeter is provided for strong stimulation. Of course, for people with solid or strong muscles, the height may be able to increase to 0.5 centimeter. In this way, we can control the degree of stimulation, which is obviously better than the uncontrollable height difference of the cobblestone road, which is easy to cause injury to the sole.

For different reflexology areas, we design stimulating media 600 with different actual stimulation heights, which can make the stimulation or massage effect reach a state of perfection.

In addition, if micro stimulation is given to the five organs (liver, heart, spleen, lung, kidney) and the six organs (large intestine, small intestine, stomach, bladder, gallbladder, Sanjiao) of a healthy user every day, it is obviously able to increase his immunity. As for users with unhealthy organs, if a relatively larger stimulation is given, their healthiness will be continuously improved unknowingly while they are walking.

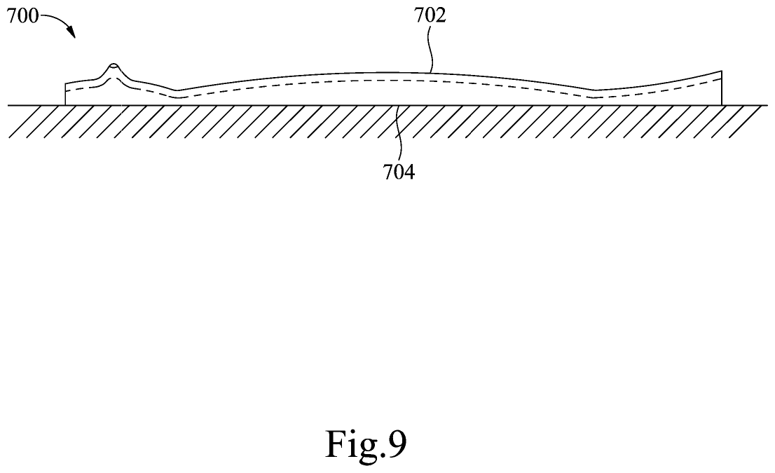

Please refer to FIG. 9, which shows a schematic cross-sectional view of the tenth embodiment of the insole assembly 700 of the present invention. It is similar to the insole in the eighth embodiment mentioned above, with the difference that its upper surface 702 fits the natural ups and downs of the sole, while its lower surface 704 is a horizontal plane, just like the insole 500 in the eighth embodiment 500. According to this design, in fact, it is the most ergonomic, and may bring infinite possibilities for human health.

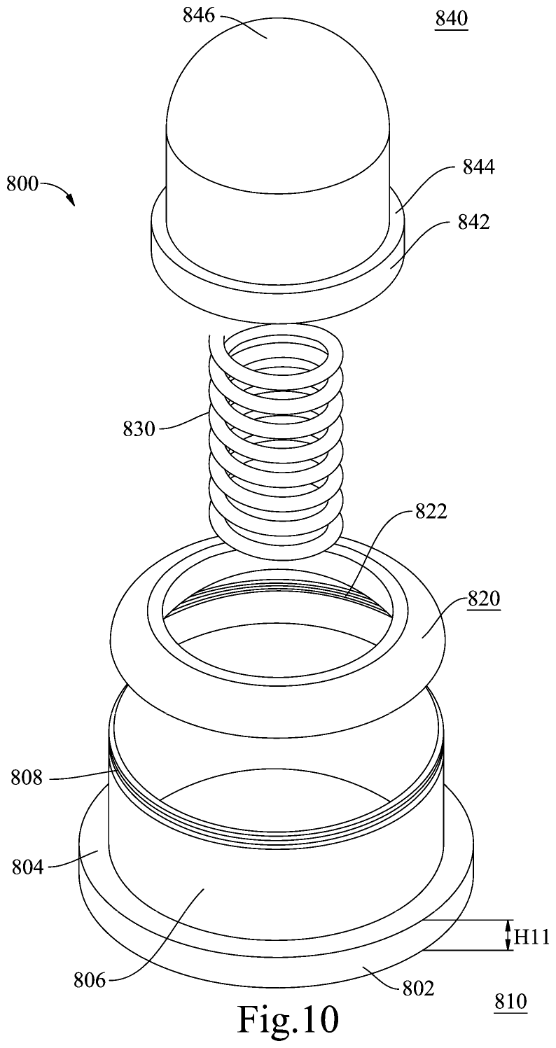

Please refer to FIG. 10, which shows another embodiment of a stimulating medium 800 of the present invention. The stimulating medium includes a stimulation base 810, a compression spring 830 and a stimulation head 840. The stimulation base 810 includes a bottom flange 802 with a thickness of H11, a base body 806 and a fastener 820. A shoulder 804 is formed between bottom flange 802 and base body 806, and base body 806 has an upper outer thread 808. Fastener 820 has a lower inner thread 822 for screwing with outer thread 808. Stimulation head 840 has a bottom flange 842, a stimulation body 846, and a shoulder 844 disposed therebetween. The inner diameter of fastener 820 is smaller than the outer diameter of bottom flange 842, so bottom flange 842 of stimulation head 840 can be buckled in base body 806. Because shoulder 844 is restrained by fastener 820, compression spring 830 will push stimulation body 846 against the selected plantar reflexology area upward with a predetermined elastic force to achieve the desired effect. Thickness H11, depending on the strength of the material (metal, plastic, rubber, etc.), which may have special properties, such as emission of far-infrared rays, is preferably between 0.1 and 1 mm. We know that when H11 is extremely small, no matter whether at least one of the upper and lower insoles, or the inner and outer insoles, is extremely soft, recess 534 in FIG. 8A is not a necessary structure. Certainly, if necessary, this kind of recess can also be disposed on the lower surface of the upper insole or the inner insole, which can be easily realized by those skilled in the art based on the disclosures of the present invention.

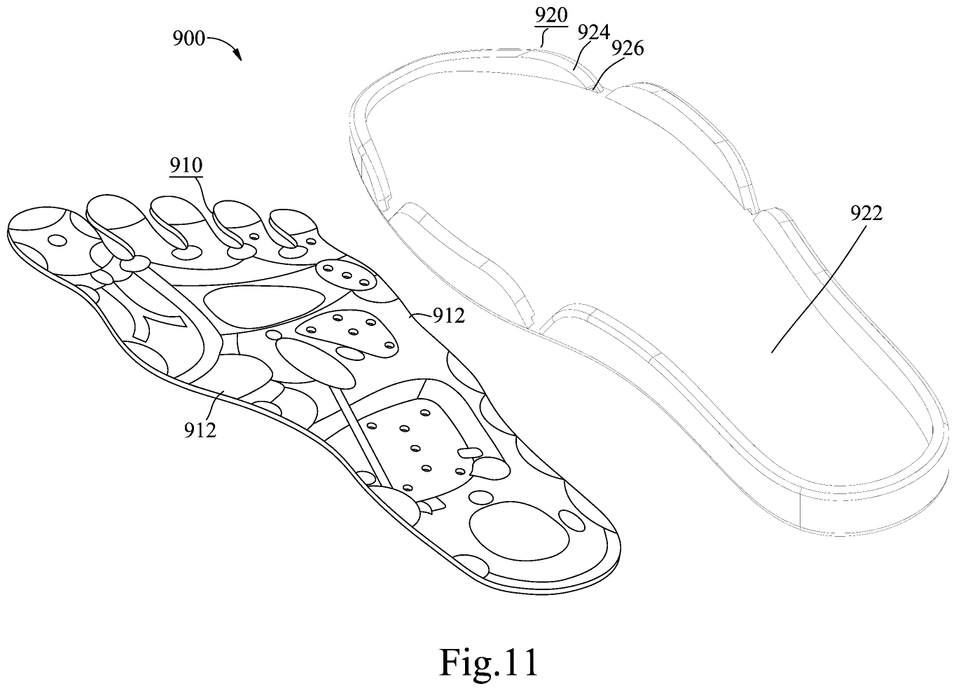

Please refer to FIG. 11, which shows a schematic diagram of an eleventh embodiment of an insole assembly 900 of the present invention. The insole assembly 900 has an upper insole 910 and a lower insole 920, wherein lower insole 920 has an insole upper surface 922, a plurality of peripheral side walls 924, and a fastening groove 926 located therebetween. When assembling, peripheral side walls 924 are pushed outward so as to snap the periphery 912 of upper insole 910 into fastening groove 926 to complete their assembly. Certainly, if the diameter of the stimulating medium is roughly equal to the diameter of the upper opening on upper insole 910, it will make the assembly process easier for the user, because the user can firstly combine the stimulating medium to upper insole 910, and then insert this combination into fastening groove 926 to obtain insole assembly 900.

Although the possible implementations of the various embodiments described above are not listed in detail, there are many mutual references or alternatives among the various embodiments, and thus one embodiment is likely to become references or alternatives for an embodiment of other implementations.

To sum up, the implementation of the present application can be modified by a person skilled in the art, and any modification therefrom does not go beyond the scope defined in the appended claims and belongs to what the applicant intends to protect.

Reflexology area including:
2: frontal sinus
4: trigeminal nerve and temporal lobe
6: left eye
8: left ear
10: head and neck lymph gland
12: mitral muscle (or trapezius muscle)
14: lungs and bronchi
16: shoulder
18: armpit/cavity
19: upper arm
20: elbow
22: knee
24: shank
26: hip
28: liver
30: gallbladder
32: transverse colon
34: ascending colon
36: small intestine
38: ileocecal valve
40: cecum and appendix
42: cold site
44: sciatic nerve
46: headache site
48: gonads
50: insomnia site
52: rectum and anus
54: bladder
56: ureter
58: navel
60: duodenum
62: lumbago site
64: pancreas
66: celiac plexus (solar plexus)
68: thyroid gland
70: parathyroid gland
72: esophagus and trachea
74: neck
76: carotid artery
78: cervical spine
80: tongue and oral cavity
82: cerebellum/brainstem
84: head/brain
86: nose
88: pituitary gland
90: right eye
92: right ear
94: heart
96: kidney
98: adrenal gland
100: spleen
102: sigmoid colon
104: stomach
200: insole
202: name of reflexology area
204: bump disposed at left ear reflexology area
206: bump disposed at shoulder reflexology area
208: bump evenly arranged at the liver reflexology area
210 & 212: bump evenly arranged at small intestine reflexology area
214: larger bump platform
216: small bump
218: stimulating medium
220: insole body
224: specific area
226: marking line
230: insole
232: stimulation position mark
240: toy sticker for use of children
242: semi-spherical grain
244: bead body
246: thin adhesive layer
248: release paper
260: insole
262: bump
280: insole
282: opening
284: defining hole circumference
286: insole body
290: columnar body
292: column upper part
294: concave ring
296: base
320: insole
322: two side extensions laterally extend
324: corresponding opening
326: defining hole circumference
328: two insole sides of the insole body
350: insole
360: inner insole
361: two insole sides
362: first engaging portion
363: lateral extensions
364: upper surface
366: marked region
368: perforation
370: outer insole
372: second engaging portion
374: lateral extensions
380: stimulating medium
382: stimulation body
384: base
400: footwear
410: inner insole
420: outer insole
430: stimulating medium opening
450: insole
460: main sole insole
462: five toes of insole
470: peripheral frame
472: five-toe cavities of the peripheral frame
480: stimulating medium opening
500: insole assembly 500
502: frontmost point of metatarsal bone
504: frontmost point of calcaneus bone
506: highest point of foot arch
508: frontmost edge of sole
510: bottom sole surface of proximal phalanx
512: upper surface of insole assembly
514: opening
520: upper insole
522: one perforated structure
524: inclined portion
526: lower surface 526
528: upper opening
529: lower connecting portion
530: lower insole
531: upper connecting portion
532: upper surface
534: recess
540: upper insole
550: lower insole
560: stimulation body of stimulating medium
600: stimulating medium
602: stimulating upper portion
604: matching intermediate portion
606: lower assembling portion
700: insole assembly
702: upper surface
704: lower surface
800: stimulating medium
802: bottom flange
804: shoulder
806: base body
808: upper outer thread
810: stimulation base
820: fastener
822: lower inner thread
830: compression spring
840: stimulation head
842: bottom flange
844: shoulder
846: stimulation body
900: insole assembly
910: upper insole
912: periphery of upper insole
920: lower insole
922: insole upper surface of lower insole
924: peripheral side wall
926: fastening groove
B: a first pore size of the perforation 368
C: centroid
D1: diametral size of base 384
D2: largest diametral size of stimulation body 382
H1: height of highest point of foot arch
H2: largest drop between palm and toe
H3: height of recess 534
H4: height of lower assembling portion 606
H5: height of matching intermediate portion
H6: height of stimulating upper part 602 is
H7: height of inclined portion 524
H8: height of upper opening 528
H9: height of lower insole 530
H10: height of upper insole 520
H11: thickness
HS: height of insole
L: line drawn through two points 502,504
1000: a pair of human feet
2000: reflexology area on right foot
3000: reflexology area on left foot

1. An insole assembly, comprising:
an inner insole having a plurality of first engaging portions, an inner insole upper surface, and a plurality of marked regions disposed on the inner insole upper surface, wherein each of the plurality of marked regions has at least one perforation and corresponds to one of a plurality of plantar reflexology areas on a sole of a user, each of the plantar reflexology areas reflexes to a related organ or a body part of the user;
an outer insole having a plurality of second engaging portions, and engaged with the inner insole by a mutual engagement of the pluralities of first and second engaging portions; and
at least one stimulating medium, each only corresponding to a single perforation of the at least one perforation, deliberately selected by the user from the plurality of marked regions to be accommodated between the inner insole and the outer insole, and having:
a first nesting end confined between the inner insole and the outer insole, and having a flat bottom; and
a second stimulating end penetrating the inner insole upper surface through the single perforation of the at least one perforation deliberately selected by the user to stimulate the sole.

2. The insole assembly according to claim 1, wherein:
the perforation has a first diametral size, the first nesting end has a second diametral size, the second stimulating end has a largest third diametral size, the second diametral size is larger than the first diametral size, and the largest third diametral size is approximately equivalent to the first diametral size; and
the outer insole has a shape of one selected from a group consisting of a slipper, a sandal, a sneaker, a casual shoe and a leather shoe.

3. The insole assembly according to claim 1, wherein the sole has two sole sides, the sole has a plurality of specific reflexology regions, and the plurality of specific reflexology regions extend laterally upward from the two sole sides, and wherein:
the inner insole further comprises two insole sides and two side portions, wherein the two side portions laterally extend upward from the two insole sides to correspond to the plurality of specific reflexology regions; and
the mutual engagement between the plurality of first engaging portions and the plurality of second engaging portions is one of a simple contact and a design of intermeshing protrusions and recesses respectively disposed on the pluralities of first and second engaging portions.

4. An insole assembly adapted for use in a footwear of a user, wherein the footwear has an inner bottom upper surface having an outline, the user has a sole having a bottom surface stepping on the inner bottom upper surface, the insole assembly is arranged between the inner bottom upper surface and the bottom surface, and the insole assembly further comprises:
an insole body having a shape conforming to the outline of the inner bottom upper surface;
a plurality of marked regions disposed on the insole body, configured to respectively correspond to a plurality of plantar reflexology areas on the sole, and each marked regions having:
a specific area corresponding to one of the plurality of plantar reflexology areas;
a marking line configured to at least partially enclose the specific area for allowing the user to easily identify the specific area; and
at least one connecting medium disposed inside the specific area; and
at least one stimulating medium configured to provide a stimulation to the bottom surface, and only stimulating the specific area deliberately selected by the user when the user wears the insole assembly.

5. The insole assembly according to claim 4, wherein the connection medium is a hole provided in the specified area, and each hole has a defining hole circumference.

6. The insole assembly according to claim 4, wherein the plurality of marked regions each has a respective corresponding plantar reflexology area reflexing to a specific organ of the user, wherein:
the sole has two sole sides, the sole has a plurality of specific reflexology regions, the plurality of specific reflexology regions extend laterally upward along the two sole sides, and the insole body further comprises two insole sides and two side portions, wherein the two side portions laterally extend upward from the two insole sides to correspond to the plurality of specific reflexology regions.

7. The insole assembly according to claim 4, wherein the insole assembly comprises an upper insole and a lower insole, in which:
the upper insole has a first insole upper surface, and the first insole upper surface has a first contour conforming to the sole of the user when the sole is in a free state or contacts nothing.

8. The insole assembly according to claim 4, wherein the at least one stimulating medium includes a plurality of stimulating pieces of different stimulation heights for coping with different actual realities of the plurality of the plantar reflexology areas.

9. An insole adapted for use in a footwear of a user through cooperating with at least one stimulating medium, wherein the footwear has an inner bottom upper surface, the user has a sole having a sole surface stepping on the inner bottom upper surface, the insole is arranged between the inner bottom upper surface and the sole surface, and the insole comprises:
an insole body having a shape conforming to the inner bottom upper surface; and
a plurality of marked regions positioned on the insole body, configured to respectively correspond to a plurality of plantar reflexology areas on the sole, and each marked regions having:
a plurality of specific areas each corresponding to one of the plurality of plantar reflexology areas; and
a marking line configured to at least partially enclose one of the plurality of specific areas for allowing the user to easily identify the one of the plurality of specific areas, so as to fix one of the at least one stimulating medium on a deliberately selected one of the plurality of specific areas.

10. The insole according to claim 9, wherein the insole further comprises a specific name inscribed on one of the plurality of specific areas.

11. The insole according to claim 9, further comprising the at least one stimulating medium, wherein one of the at least one medium is adhered onto one of the plurality of specific areas by an adhesive.

12. The insole according to claim 9, further comprising a plurality of stimulation position marks disposed on the plurality of the specific areas respectively, wherein:
the plurality of stimulation position marks have the same shape and a same dimension; and
the nearer a circle to a centroid of a respective specific area, the larger quantity the circle has the stimulation position marks.

13. The insole assembly according to claim 12, wherein.
the sole has two sole sides, the sole has a plurality of specific reflexology regions, the plurality of specific reflexology regions extend laterally upward from the two sole sides, and the insole body further comprises two insole sides and two side portions, and
the two side portions laterally extend upward from the two insole sides to correspond to the plurality of specific reflexology regions of the two sole sides.

14. The insole assembly according to claim 4, wherein the at least one stimulating medium is generally cylindrical, and includes a cylindrical upper part configured to stimulate one of the plurality of plantar reflexology areas, an intermediate annular groove matching with the connecting medium, and a base arranged between the insole body and the inner bottom upper surface.

15. The insole assembly according to claim 4, wherein the at least one stimulating medium includes a stimulating base, a pressure spring and a stimulating head, and wherein:
the stimulating base has a bottom flange, a base body and a fastener;
a first shoulder is formed between the base body and the bottom flange having an outer diameter;
the base body has an upper end external thread, and the fastener has a lower internal thread for a threaded connection with the upper end external thread;
the stimulating head has a bottom edge, a stimulation body, and a second shoulder disposed therebetween; and
the fastener has an inner diameter smaller than the outer diameter of the bottom flange, and, on a condition that the second shoulder is fastened by the fastener, the pressure spring urges the stimulation body upward against one of the plurality of plantar reflexology areas with a predetermined elastic force.

16. The insole assembly according to claim 7, wherein the lower insole has a second lower insole surface, and the second lower insole surface is in a horizonal plane and has a second contour conforming to the sole of the user when the sole is in a free state or contacts nothing.

17. The insole assembly according to claim 4, wherein, in the insole assembly:
the upper insole has a first insole upper surface, a first insole lower surface and at least one perforated structure corresponding to one of a plurality of plantar reflexology areas, and wherein:
the at least one perforated structure has an inclined portion and an upper opening;
the at least one stimulating medium has a stimulating upper portion, a matching intermediate portion and a lower assembling portion;
the lower insole has a second insole upper surface, wherein the second insole upper surface has at least one recess;
the lower assembling portion is accommodated in a respective one of the least one recess;
the matching intermediate portion and the inclined portion match each other so that the stimulating upper portion protrudes from the upper opening of the perforated structure to stimulate the sole of the user;
the first insole lower surface matches with the second insole upper surface; and
a respective one of the at least one perforated structure and a corresponding one of the at least one recess collaboratively assemble therewith a corresponding one of the at least one stimulating medium.

18. The insole according to claim 10, wherein each of the plurality of specific areas further comprises at least one stimulation position mark being one of a hole or a marked symbol.

19. The insole according to claim 9, further comprising the at least one stimulating medium, wherein the at least one stimulating medium has a lower platform and a plurality of upper stimulating bumps.

20. The insole assembly according to claim 12, wherein the insole body has a main insole and a peripheral frame jacketing thereto the main insole.
